(19) United States
(12) Patent Application Publication
(10) Pub. No.: US 2025/0219692 A1
(43) Pub. Date: Jul. 3, 2025

(54) Adaptive Channel Aging Detection to Determine Channel Sounding Intervals

(71) Applicant: Cisco Technology, Inc., San Jose, CA (US)

(72) Inventors: Niloo Bahadori, Greensboro, NC (US); Peiman Amini, Fremont, CA (US); Ardalan Alizadeh, Milpitas, CA (US); Brian D. Hart, Sunnyvale, CA (US); Binita Gupta, San Diego, CA (US)

(73) Assignee: Cisco Technology, Inc., San Jose, CA (US)

(21) Appl. No.: 18/786,344

(22) Filed: Jul. 26, 2024

Related U.S. Application Data
(60) Provisional application No. 63/615,416, filed on Dec. 28, 2023.

(51) Int. Cl. H04B 7/06; H04L 25/02; H04L 27/26

(52) U.S. Cl. CPC H04B 7/0626; H04L 25/0252; H04L 27/2603

(57) ABSTRACT

Adaptive channel aging detection to determine channel sounding intervals in a wireless network is provided. A station may receive data packets from an Access Point (AP) over a channel established between the AP and the station. The station may estimate a channel condition of the channel based on Legacy Long Training Field (L-LTF) symbols in the data packets. The station may determine an amount of variation in the channel condition estimated so far from a latest Channel Sounding Information (CSI) report. The station may determine whether the latest CSI report is still valid based on the variation.

### RELATED APPLICATION

Under provisions of 35 U.S.C. § 119(e), Applicant claims the benefit of U.S. Provisional Application No. 63/615,416, filed Dec. 28, 2023, which is incorporated herein by reference.

### TECHNICAL FIELD

The present disclosure relates generally to adaptive channel aging detection to determine channel sounding intervals in a wireless network.

### BACKGROUND

Institute of Electrical and Electronics Engineers (IEEE) 802.11 is part of the IEEE 802 Local Area Network (LAN) protocols. Channel sounding is an integral part of IEEE 802.11 operation that is performed before various types of wireless transmissions. Channel sounding is required for Multi-User Multiple Input Multiple Output (MU-MIMO) applications and Single-User Multiple Input Multiple Output (SU-MIMO) applications. During channel sounding, channel measurements need to be performed frequently to determine a channel state and provide quality of service.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an example operating environment;

FIG. 2 illustrates a transmission sequence of an exemplary channel sounding process in a multi-link wireless network;

FIG. 3 is a flow diagram of a method for adaptive channel aging detection to determine channel sounding in a wireless network;

FIG. 4 illustrates a data packet of a wireless network; and

FIG. 5 is a block diagram of a computing device.

### DETAILED DESCRIPTION

### Overview

Adaptive channel aging detection to determine channel sounding intervals in a wireless network is provided. A station may receive data packets from an Access Point (AP) over a channel established between the AP and the station. The station may estimate a channel condition of the channel based on Legacy Long Training Field (L-LTF) symbols in the data packets. The station may determine an amount of variation in the channel condition estimated so far from a latest Channel Sounding Information (CSI) report. The station may determine whether the latest CSI report is still valid based on the variation.

Both the foregoing overview and the following example embodiments are examples and explanatory only, and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Channel sounding may typically be performed in Wi-Fi networks to determine a wireless communication channel state before various types of transmissions between Access Points (APs) and wireless client devices of the network, including Multi-User Multiple Input Multiple Output (MU-MIMO) and Single User Multiple Input Multiple Output (SU-MIMO). As one example, for distributed MIMO used as part of multi-AP coordination or MIMO with 16 Spatial Streams (SSs) proposed in Institute of Electrical Engineers (IEEE) 802.11be, frequent channel sounding may be needed to gain knowledge of the channel state. Accurate MU-MIMO beamforming may require stations to report accurate Channel Sounding Information (CSI) to the AP. The accuracy of the CSI may depend not only on the station's ability to correctly estimate the channel but also on channel sounding intervals. An indoor wireless propagation environment may vary drastically over time, affecting the estimated CSI's reliability and validity. Therefore, the estimated CSI may need to be updated regularly to capture the changes in wireless channels.

More frequent CSI estimation/report may increase the network overhead and less frequent CSI estimation/report leads to the utilization of obsolete CSI which in turn may cause inaccurate beamforming, increased interference, and throughput degradation. Therefore, it may be imperative to optimize the channel sounding intervals to prevent excessive overhead while maintaining the reliability of the channel estimation. One approach to address this problem may be to define a fixed channel sounding interval. However, this approach may not efficient since it may lead to unnecessary channel sounding in static environments and insufficient channel soundings in dynamic environments. Another approach to address this problem may be for the AP to initiate channel sounding and ask the station to update the CSI when throughput degrades below a threshold. This approach may also not be ideal since the channel sounding may not be triggered until after a throughput degrades and the station is impacted.

Embodiments of the disclosure provide that the station may use legacy preambles in data packets being received on a channel to determine a channel condition of the channel. For example, symbols in Legacy Long Training Field (L-LTF) from the data packets the station receives may be used to estimate the channel condition. The L-LTF may include known symbols. By analyzing how the L-LTF symbols differ from their known values, the station may infer or estimate the channel condition. The estimated channel condition may be stored in a memory. A standard deviation may be determined over all estimated channel conditions so far from a latest CSI report.

In one aspect, the standard deviation may be provided to the AP, for example, through an Acknowledgment (ACK) message, a Buffer Status Report (BSR) message, or Clear to Send (CTS) message. The AP may decide according to Quality of Service (QOS) requirements and inaccuracy in a Beamforming (BF) matrix to trigger another round of channel sounding or reuse the BF matric. In another aspect, the station may use the standard deviation and determine whether a latest CSI report is still valid or the CSI report may need to be updated. This determination may be sent in an ACK message, a BSR message, or a CTS message to the AP. In some examples, a new signaling mechanism may be defined to send the standard deviation or the decision on whether the latest CSI report is valid to the AP.

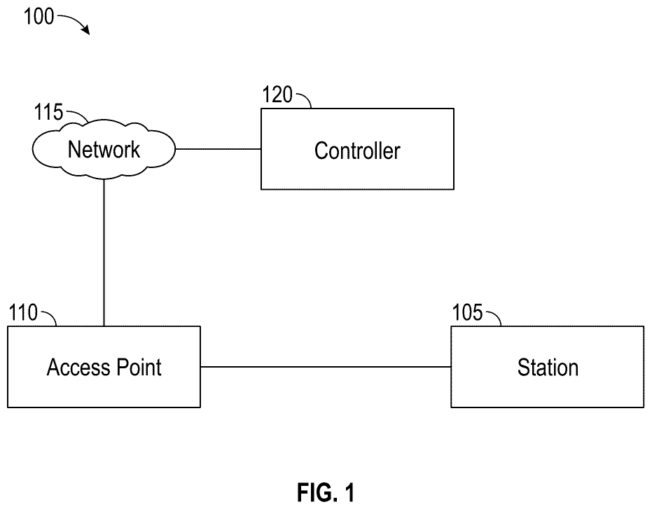

FIG. 1 shows an operating environment 100 for adaptive channel aging detection to determine channel sounding intervals in a wireless network. As shown in FIG. 1, operating environment 100 may comprise a station 105, an AP 110, a network 115, and a controller 120. However, operating environment 100 is not so limited and may include multiple APs and multiple stations. AP 110 may be associated with one or more stations, including station 105. AP 110 may provide an access to network 115 (e.g., a Wireless Local Area Network (WLAN)) to station 105.

Station 105 may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. AP 110 may be compatible with specification standards such as, but not limited to, the Institute of Electrical and Electronics Engineers (IEEE) 802.11 specification standard for example.

Controller 120 may comprise a WLAN controller and may provision and control operating environment 100 (e.g., the WLAN). Controller 120 may allow the plurality of user devices to join operating environment 100. In some examples, controller 120 may be implemented by a Digital Network Architecture Center (DNAC) controller (i.e., a Software-Defined Network (SDN) controller).

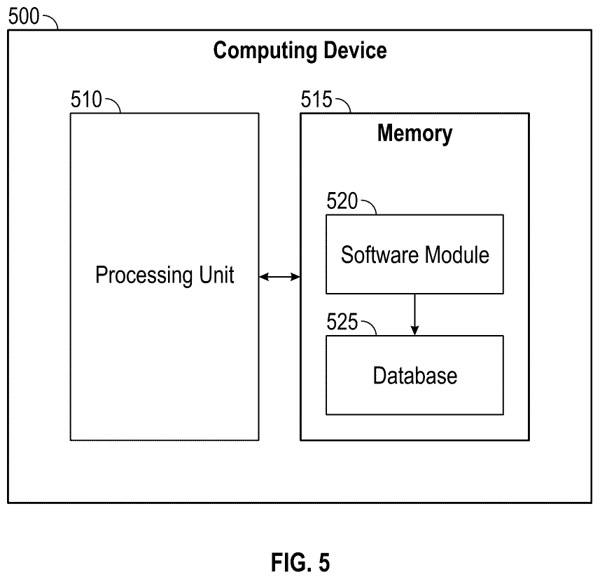

The elements described above of operating environment 100 (e.g., station 105, AP 110, and controller 120) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 5, the elements of operating environment 100 may be practiced in a computing device 500.

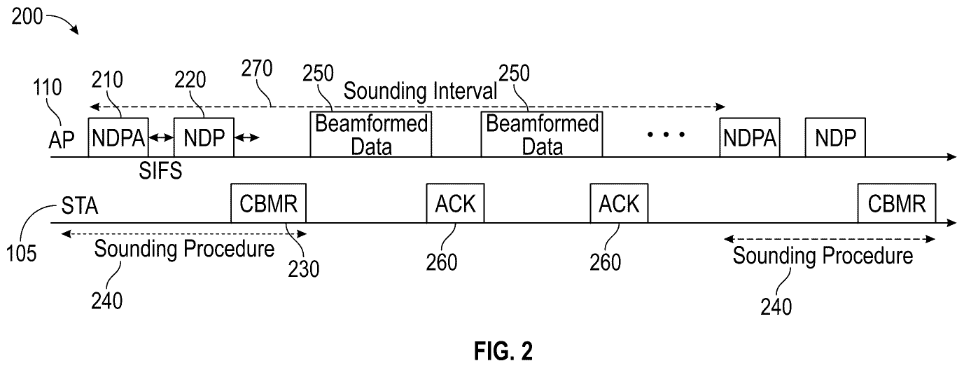

FIG. 2 is a diagram illustrating a transmission sequence for an exemplary channel sounding process in a wireless network, such as operating environment 100 described in FIG. 1. Station 105 and AP 110 may establish a channel to transmit and receive data. To begin the data transmission, AP 110 may transmit a sounding trigger, for example, a Null Data Packet Announcement (NDPA) frame 210. NDPA frame 210 may be used to gain control of the channel and may include information of station 105 from which AP 110 is to collect Channel State Information (CSI). NDPA frame 210 may also specify a subcarrier grouping, a resolution for CSI quantization, and a frequency range for which AP 110 may request CSI feedback. Next, a Null Data Packet (NDP) frame 220 used by station 105 to measure the channel condition may be transmitted. A time gap between transmission of NDPA frame 210 and NDP frame 220 may be referred to as a Short Inter-fame Space (SIFS).

Station 105 may create a Compressed Beamforming Matrix Report (CBMR) frame 230 using the NDPA frame 210 and NDP frame 220. Station 105 may transmit (CBMR) frame 230 to AP 110. Station 105 may use training fields in NDP frame 220 to determine CBMR frame 230. Sending of CBMR frame 230 may indicate completion of a channel sounding procedure 240. AP 110 may use CBMR frame 230 to determine a steering matrix or a BF matrix. Based on the steering matrix, AP 110 may transmit beamformed data frames 250 to station 105. Station 105 may send an acknowledgment (ACK) frame 260 to each beamformed data frame 250. At an end of a channel sounding interval 270, AP 110 may re-trigger channel sounding procedure 240 for the channel by resending NDPA frame 210 again. This process may be repeated for each channel sounding interval 270.

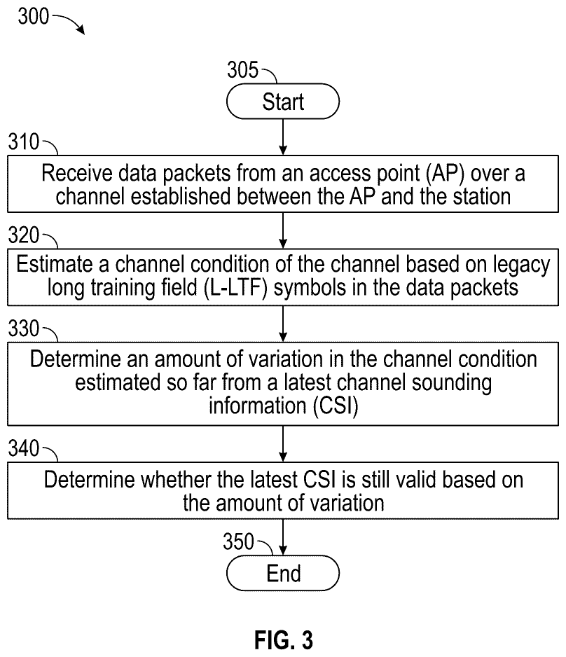

FIG. 3 is a flow chart setting forth the general stages involved in a method 300 consistent with embodiments of the disclosure for adaptive channel aging detection to determine channel sounding interval in a wireless network. Method 300 may be implemented using station 105 as described in more detail above with respect to FIG. 1. However, method 300 may be implemented using any of AP 110 and controller 120 as described in more detail above with respect to FIG. 1. Ways to implement the stages of method 300 will be described in greater detail below.

Method 300 may begin at starting block 305 and proceed to stage 310 where station 105 may receive data packets from AP 110 over a channel established between AP 110 and station 105. These data packets may include beamformed data frames 250 that were beamformed based on a steering matrix derived from a latest CSI report.

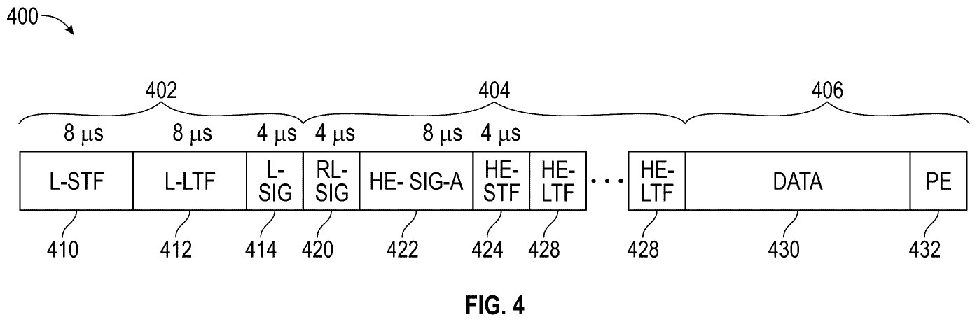

After receiving data packets from AP 110 at stage 310, method 300 proceeds to stage 320 where station 105 estimates a channel condition of the channel based on L-LTF symbols in the data packets. FIG. 4 illustrates an example data packet 400 of a wireless network. Data packet 400 may be a Physical Layer Protocol Data Unit (PPDU) that may be used for CDMA, Time Division Multiple Access (TDMA), Frequency Division Multiple Access (FDMA), Orthogonal FDMA (OFDMA), Single-Carrier FDMA (SC-FDMA), Single-User (SU) Multiple-Input Multiple-Output (MIMO), or Multi-User (MU) MIMO transmissions.

Data packet 400 may be formatted as a High Efficiency (HE) WLAN PPDU in accordance with the IEEE 802.11ax amendment to the IEEE 802.11 wireless communication protocol standard. As shown in FIG. 4, data packet 400 includes a legacy preamble 402 (also referred to as a PHY preamble), an HE preamble 404, and a payload 406. HE preamble 404 and payload 406 together are also referred to as a non-legacy portion.

Legacy preamble 402 may include a Legacy Short Training Field (L-STF)-STF) 410, which may consist of Binary Phase Shift Keying (BPSK) symbols, a Legacy Long Training Field (L-LTF) 412, which may include BPSK symbols, and a Legacy Signal Field (L-SIG) 2414, which may also include BPSK symbols. Legacy preamble 402 may be configured according to the IEEE 802.11a wireless communication protocol standard.

L-STF 410 may generally enable a receiving device (for example, station 105) to perform Automatic Gain Control (AGC) and coarse timing and frequency estimation. L-LTF 208 may generally enable a receiving device (for example, station 105) to perform fine timing and frequency estimation and also to perform an initial estimate of the wireless channel. L-SIG 210 may generally enable a receiving device (for example, station 105) to determine a duration of data packet 400 and to use the determined duration to avoid transmitting on top of data packet 400.

HE preamble 404 may include a Repetition of L-SIG (RL-SIG) 420, a first HE signal field (HE-SIG-A) 422, a HE Short Training Field (HE-STF) 424, and one or more HE Long Training Fields (or symbols) (HE-LTFs) 428. Payload 406 may include data 430 and a Packet Extension (PE) 432.

Referring back to FIG. 3, station 105 may use the BPSK symbols in L-LTF 412 of received data packet 400 to estimate channel conditions of the channel between station 105 and AP 110. For example, by analyzing how the received BPSK symbols of L-LTF 412 differ from their know values, station 105 may estimate the channel condition. Station 105 may estimate the channel condition for multiple successive data packets received from the last CSI report. In examples, station 105 may estimate the channel condition for each data packets received from the last CSI report. In some examples, station 105 may estimate the channel condition for selected data packets received from the last CSI report. Station 105 may store the channel conditions with respective time of receipt of the data packet.

Once having estimated the channel condition based on L-LTF 412 symbols at stage 320, method 300 may proceed to stage 330 where station 105 may determine an amount of variation in the channel condition estimated so far from the latest CSI. In some examples, station 105 may determine a standard deviation of the channel condition over all samples estimated so far from a latest CSI report.

After determining the amount of variation in the channel condition estimated so far from the latest CSI at stage 330, method 300 may proceed to stage 340 where station 105 may determine whether the latest CSI report is still valid based on the amount of variation. For example, station 105 may determine the latest CSI report to be not valid if the amount of variation is greater than a predetermined value. In response to determining that the latest CSI report is not valid, station 105 may send an indication to AP 110 that the CSI report may need to be updated. Such indication may be sent in an ACK message, a BSR message, or CTS message. In some implementations, a new signaling mechanism may be defined to send the indication that the CSI report may need to be updated.

In example implementation, station 105 may send the amount of variation in the channel conditions estimated so far from the latest CSI report to AP 110. AP 110 may determine whether the latest CSI report is still valid based on the amount of variation. In response to determining that the CSI report needs to be updated, AP 110 may initiate channel sounding procedure 240 to update the CSI report. Method 400 may terminate at End block 450.

FIG. 5 shows computing device 500. As shown in FIG. 5, computing device 500 may include a processing unit 510 and a memory unit 515. Memory unit 515 may include a software module 520, database 525, and additional logic. While executing on processing unit 510, software module 520 may perform, for example, processes for adaptive channel aging detection to determine channel sounding intervals in a wireless network as described herein. Computing device 500, for example, may provide an operating environment for station 105, AP 110, and controller 120, etc. Other operational environments may be utilized and the present disclosure is not limited to computing device 500.

Computing device 500 may be implemented using a Wi-Fi access point, a cellular base station, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay devices, or other similar microcomputer-based device. Computing device 500 may comprise any computer operating environment, such as hand-held devices, multiprocessor systems, microprocessor-based or programmable sender electronic devices, minicomputers, mainframe computers, and the like. Computing device 500 may also be practiced in distributed computing environments where tasks are performed by remote processing devices. The aforementioned systems and devices are examples and computing device 500 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where elements may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 600 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
receiving, by a station, data packets from an Access Point (AP) over a channel established between the AP and the station;
estimating, by the station, a channel condition of the channel based on Legacy Long Training Field (L-LTF) symbols in the data packets;
determining, by the station, an amount of variation in the channel condition estimated so far from a latest Channel Sounding Information (CSI) report; and
determining, by the station, whether the latest CSI report is still valid based on the amount of variation.

2. The method of claim 1, wherein determining the amount of variation in the channel condition comprises determining a standard deviation in the channel condition estimated so far from the latest CSI report.

3. The method of claim 1, wherein estimating the channel condition of the channel based on the L-LTF symbols in the data packets comprises determining a difference between known values of the L-LTF symbols and received values of the L-LTF symbols.

4. The method of claim 1, further comprising:
determining, by the station, that the latest CSI report needs to be updated in response to determining that the latest CSI report is not valid.

5. The method of claim 4, further comprising:
sending, by the station, a report comprising determination that the latest CSI report needs to be updated.

6. The method of claim 4, further comprising:
sending, by the station, a report comprising determination that the latest CSI report is not valid.

7. The method of claim 4, further comprising:
sending, by the station, the report in an acknowledgement message.

8. The method of claim 1, wherein estimating the channel condition of the channel based on the L-LTF symbols in the data packets comprises estimating the channel condition of the channel based on the symbols in each of the data packets.

9. A system comprising:
a memory storage; and
a processing unit coupled to the memory storage, wherein the processing unit is operative to:
receive data packets from an Access Point (AP) over a channel established between the AP and a station;
estimate a channel condition of the channel based on Legacy Long Training Field (L-LTF) symbols in the data packets;
determine an amount of variation in the channel condition estimated so far from a latest Channel Sounding Information (CSI) report; and
provide the variation in the channel condition to the AP.

10. The system of claim 9, wherein the processing unit being operative to determine the amount of variation in the channel condition comprises the processing unit being operative to determine a standard deviation in the channel condition estimated so far from the latest CSI report.

11. The system of claim 9, wherein the processing unit being operative to estimate the channel condition of the channel based on the L-LTF symbols in the data packets comprises the processing unit being operative to determine a difference between known values of the L-LTF symbols and received values of the L-LTF symbols.

12. The system of claim 9, wherein the processing unit is further operative to:
send the variation in the channel condition in an acknowledgement message.

13. The system of claim 9, wherein the processing unit being operative to estimate the channel condition of the channel based on the L-LTF symbols in the data packets comprises the processing unit being operative to estimate the channel condition of the channel based on the symbols in each of the data packets.

14. A non-transitory computer readable medium that stores a set of instructions which when executed perform a method executed by the set of instructions comprising:
receiving, by a station, data packets from an Access Point (AP) over a channel established between the AP and the station;
estimating, by the station, a channel condition of the channel based on Legacy Long Training Field (L-LTF) symbols in the data packets;
determining, by the station, an amount of variation in the channel condition estimated so far from a latest Channel Sounding Information (CSI) report; and
determining, by the station, whether the latest CSI report is still valid based on the amount of variation.

15. The non-transitory computer readable medium of claim 14, wherein estimating the channel condition of the channel based on the L-LTF symbols in the data packets comprises estimating the channel condition of the channel based on the symbols in each of the data packets.

16. The non-transitory computer readable medium of claim 14, wherein determining the amount of variation in the channel condition comprises determining a standard deviation in the channel condition estimated so far from the latest CSI report.

17. The non-transitory computer readable medium of claim 14, wherein estimating the channel condition of the channel based on the L-LTF symbols in the data packets comprises determining a difference between known values of the L-LTF symbols and received values of the L-LTF symbols.

18. The non-transitory computer readable medium of claim 14, wherein the method executed by the set of instructions further comprising:
determining, by the station, that the latest CSI report needs to be updated in response to determining that the latest CSI report is not valid.

19. The non-transitory computer readable medium of claim 18, wherein the method executed by the set of instructions further comprising:
sending, by the station, an indication comprising determination that the latest CSI report needs to be updated.

20. The non-transitory computer readable medium of claim 19, wherein the method executed by the set of instructions further comprising:
sending, by the station, the indication in an acknowledgement message.
